(19) United States
(12) Patent Application Publication
(10) Pub. No.: US 2022/0271279 A1
(43) Pub. Date: Aug. 25, 2022

(54) ANODE HAVING HIGH TOP LAYER SPHERICITY

(71) Applicant: EnPower, Inc., Phoenix, AZ (US)

(72) Inventors: Adrian YAO, Phoenix, AZ (US); Jonathan HWANG, Phoenix, AZ (US); Dee STRAND, San Diego, CA (US)

(21) Appl. No.: 17/742,601

(22) Filed: May 12, 2022

Related U.S. Application Data
(63) Continuation-in-part of application No. 17/111,310, filed on Dec. 3, 2020.
(60) Provisional application No. 63/113,108, filed on Nov. 12, 2020.
(60) Provisional application No. 63/214,728, filed on Jun. 24, 2021.

(51) Int. Cl. H01M 4/36; H01M 4/587; H01M 4/04; H01M 4/133; H01M 4/1393; H01M 10/0525

(52) U.S. Cl. CPC H01M 4/366; H01M 4/587; H01M 4/0404; H01M 4/0435; H01M 4/133; H01M 4/1393; H01M 10/0525; H01M 2004/027

(57) ABSTRACT

Anodes having high top layer sphericity may include a first active material layer including a plurality of first active material particles having a first particle sphericity and a first particle size layered onto and directly contacting a current collector, and a second active material layer including a plurality of second active material particles having a second particle sphericity and a second particle size layered onto and directly contacting the first layer. The second particle sphericity is greater than the first particle sphericity. In some examples, the second particle size is greater than the first particle size.

### CROSS-REFERENCES

The following applications and materials are incorporated herein, in their entireties, for all purposes: U.S. Provisional Patent Application Ser. No. 63/113,108, filed Nov. 12, 2020; and U.S. Provisional Patent Application Ser. No. 63/214,728, filed Jun. 24, 2021.

### FIELD

This disclosure relates to systems and methods for electrochemical cells. More specifically, the disclosed embodiments relate to multilayered electrodes for electrochemical cells.

### INTRODUCTION

Environmentally friendly sources of energy have become increasingly critical, as fossil fuel-dependency becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), lithium ion (Li-ion), and lithium ion polymer (Li-ion polymer).

### SUMMARY

The present disclosure provides systems, apparatuses, and methods relating to anodes having high top layer sphericity.

In some examples, an electrode according to aspects of the present disclosure comprises: a current collector substrate; and an active material composite disposed on the current collector substrate, wherein the active material composite comprises: a first layer adjacent the current collector substrate and comprising first active material particles having a first average particle sphericity and a first average particle size; and a second layer on and directly contacting the first layer and comprising second active material particles having a second average particle sphericity and a second average particle size; wherein the second average particle sphericity is greater than the first average particle sphericity, such that a path through the second layer is less tortuous than a path through the first layer.

In some examples, an electrode according to aspects of the present disclosure comprises: a current collector substrate; a first active material composite layer on and directly contacting the current collector substrate, the first active material layer comprising a plurality of first active material particles adhered together by a first binder, the plurality of first active material particles having a first average particle sphericity; and a second active material composite layer on and directly contacting the first active material layer, the second active material layer comprising a plurality of second active material particles adhered together by a second binder, the plurality of second active material particles having a second average particle sphericity; wherein the second average particle sphericity is greater than the first average particle sphericity, such that a path through the second active material layer is less tortuous than a path through the first active material layer.

In some examples, a method of manufacturing an anode according to aspects of the present disclosure comprises: layering a first active material composite onto a current collector, the first active material composite comprising a plurality of first active material particles having a first average particle sphericity; and layering a second active material composite onto the first active material composite, the second active material composite comprising a plurality of second active material particles having a second average particle sphericity; wherein the second average particle sphericity is greater than the first average particle sphericity.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic sectional view of an illustrative electrochemical cell.

FIG. 2 is a schematic sectional view of a portion of an electrochemical cell having a first illustrative multilayered electrode, depicted accepting lithium ions in a lithiation process.

FIG. 3 is a schematic sectional view of an illustrative multilayered anode having high top layer sphericity, in accordance with aspects of the present disclosure.

FIG. 4 is a schematic diagram illustrating potential particles for inclusion in a top layer of the anode of FIG. 3, arranged based on particle sphericity and particle roundness.

FIG. 5 is a photograph of an illustrative anode including illustrative particles having high degrees of sphericity.

FIG. 6 is a Nyquist plot of: an electrode including large spherical particles in a top layer only, an electrode including a mixture of large spherical particles and high aspect ratio particles in a top layer, and an electrode including high aspect ratio particles in a top layer only.

FIG. 7 is a Nyquist plot of: an electrode including a homogeneous blend of large spherical particles and high aspect ratio particles, and an electrode including a multilayered structure and including large spherical particles in a top layer and high aspect ratio particles in a bottom layer.

FIG. 8 is a flow chart depicting steps of an illustrative method for manufacturing anodes in accordance with aspects of the present disclosure.

FIG. 9 is a sectional view of an illustrative electrode undergoing a calendering process in accordance with aspects of the present disclosure.

FIG. 10 is a schematic diagram of an illustrative manufacturing system suitable for manufacturing cathodes and electrochemical cells of the present disclosure.

### DETAILED DESCRIPTION

Various aspects and examples of anodes having high top layer sphericity are described below and illustrated in the associated drawings. Unless otherwise specified, an anode in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

“D50” refers to the mass-median diameter of a particle or plurality of particles.

“MCMB” refers to mesocarbon microbead graphite.

“Adjacent” means next to or adjoining. For example, a first electrode layer may be adjacent a second electrode layer if the first electrode is next to the second electrode layer. In some examples, the first electrode layer may adjoin the second electrode layer by way of an interphase layer which couples the first electrode layer to the second electrode layer.

“Tortuosity” refers to the overall expediency of paths through an electrode. In some examples, the tortuosity of a path through the electrode may refer to the ratio of actual flow path length to the straight distance between the ends of the flow path within the electrode, also known as the arc-chord ratio. In some examples, the tortuosity of an electrode refers to a ratio of the diffusivity in the free space of the electrode to the diffusivity in the porous medium of the electrode. In some examples, the effective diffusivity of an electrode is proportional to the reciprocal of the square of the geometric tortuosity. In some examples, the overall tortuosity of an electrode may be described by the equation:

$$\frac{τ}{ε} = \frac{{ρ}_{eff}}{{ρ}_{0}} = \frac{{κ}_{0}}{{κ}_{eff}} = \frac{{D}_{0}}{{D}_{eff}} = {N}_{M}$$

where τ is the tortuosity factor; ε is the porosity; N_{M} is the MacMullin number; ρ₀, κ₀, and D₀ are, respectively, the “intrinsic” electrical resistivity (Ω m), conductivity (S m⁻¹) and diffusion coefficient (m²s¹) of the electrolyte; and β_{eff}, κ_{eff}, and D_{eff} are the observed “effective” values resulting from the transport constraints imposed by a porous and tortuous microstructure.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

Overview

Electrode efficiency is generally influenced by a “path length” that lithium ions must travel between an anode active material particle and a cathode active material particle. The expediency of this path, e.g., how winding or direct the path is, may generally be referred to as “tortuosity.” Similarly, the tortuosity of a porous material (e.g., an electrode, electrochemical cell, etc.) may refer to a rate of diffusion or fluid flow through the porous material. As a path becomes more tortuous, or the tortuosity of an electrode increases, an impedance of the electrochemical cell increases, and a potential charging and discharging speed of the electrochemical cell decreases.

An electrochemical cell including electrodes having relatively low tortuosity may increase a charging speed of an electrochemical cell and reduce an overall impedance of the electrochemical cell. The morphology of electrode materials included within an electrode is the most important factor which affects electrode tortuosity. Including large active material particles having a high degree of sphericity in a top layer of a multilayered electrode reduces electrode tortuosity and increases electrode efficiency.

In general, an electrode (e.g., anode) having high top layer sphericity includes a first (AKA bottom) active material layer including a first plurality of active material particles having a first particle sphericity and a first particle size, layered onto and directly contacting a current collector, and a second (AKA top) active material layer including a second plurality of large active material particles having a second particle sphericity greater than the first particle sphericity and a second particle size, layered onto and directly contacting the first active material layer. In some examples, the second plurality of large active material particles have an average D50 greater than 15 μm.

Particle sphericity can be defined in several ways. Generally, at least 50% of active material particles included in the top electrode layer satisfy at least two of the following conditions:

$$Sphericity of silhouette ( of cross - sectional profile ) = \frac{{r}_{max - in}}{{r}_{min - cir}} \geq 0.6 ,$$

wherein rₘₐₓ₋ᵢₙ refers to the radius of the largest circle that can be inscribed within the particle silhouette, and wherein r_{min-cir} refers to the radius of the smallest circle that fully circumscribes the particle silhouette.

$$Circularity of silhouette ( of cross - sectional profile ) = \frac{4 π * area}{{perimeter}^{2}} \geq 0.6$$

$$Roundness of silhouette ( of cross - sectional profile ) = \frac{area}{π * major {axis}^{2}} \geq 0.5$$

$$Aspect ratio of silhouette ( of cross - sectional profile ) = \frac{major axis}{minor axis} \leq 2$$

In some examples, the sphericity of silhouette of a cross-sectional profile refers to an average sphericity of silhouette of the average cross-sectional profiles of each active material particle. In some examples, the sphericity of silhouette of a cross-sectional profile refers to an average sphericity of silhouette of active material particles measured at a specific cross-section of the electrode. In some examples, the circularity of silhouette of a cross-sectional profile refers to an average circularity of silhouette of the average cross-sectional profiles of each active material particle. In some examples, the circularity of silhouette of a cross-sectional profile refers to an average circularity of silhouette of active material particles measured at a specific cross-section of the electrode. In some examples, the roundness of silhouette of a cross-sectional profile refers to an average roundness of silhouette of the average cross-sectional profiles of each active material particle. In some examples, the roundness of silhouette of a cross-sectional profile refers to an average roundness of silhouette of active material particles measured at a specific cross-section of the electrode. In some examples, the aspect ratio of silhouette of a cross-sectional profile refers to an average aspect ratio of silhouette of the average cross-sectional profiles of each active material particle. In some examples, the aspect ratio of silhouette of a cross-sectional profile refers to an average aspect ratio of silhouette of active material particles measured at a specific cross-section of the electrode.

In some examples, at least 50% of active material particles included in the top electrode layer satisfy a single condition to a high degree, and so must only conform to a single condition to be suitable for inclusion in the top electrode layer. For example, active material particles having a sphericity of silhouette greater than 0.9 are suitable for use in the top layer of an electrode without meeting another condition. Ideal active material particles for use in the top layer have both a roundness of silhouette greater than 0.5 and a sphericity greater than 0.7.

Active material particles included in the bottom layer are generally less spherical than active material particles included in the top layer. Accordingly, at least 50% of active material particles included in the bottom electrode layer satisfy at least one of the following conditions:

$$Circularity of Silhouette ( of cross - sectional profile ) = \frac{4 π * area}{{perimeter}^{2}} < 0.6$$

$$Roundness of silhouette ( of cross - sectional profile ) = \frac{area}{π * major {axis}^{2}} \leq 0.5$$

$$Aspect ratio of silhouette ( of cross - sectional profile ) = \frac{major axis}{minor axis} > 2$$

Conditions described above refer to active material particles included in calendered electrodes. Electrode particles may be analyzed using cross-sectional analysis, (e.g., ion-milling, focused-ion beam, scanning electron microscope) to determine if the electrode particles meet the above conditions and are suitable for inclusion in electrode layers.

In some examples, the electrode having high top layer sphericity is an anode. In some examples, the second plurality of active material particles comprise a spherical natural graphite. Spherical natural graphite is low-cost, has high capacity, and high-rate capability given its spheroidized morphology, which provides graphite edge-plane access all around the particle surface (as opposed to flake graphite, which provides edge-plane access only along edges). However, spherical natural graphite has internal porosity, which may lead to some loss of sphericity upon calendering, and may lead to reduced cycle life due to material impurities in natural graphite raw materials. In some examples, the second plurality of active material particles comprise a mesocarbon microbead (MCMB) graphite, which is an artificial and/or synthetic graphite. MCMB graphite has a high degree of sphericity. Brooks-Taylor structure found in mesophase graphite results in a high degree of edge-plane access all around the particle surface (different from that found in natural graphite), which yields high rate capability. While natural graphite also provides edge-plane access, natural graphite includes overlapping graphite sheets (e.g., like a cabbage). MCMB graphites have edge planes disposed similarly to the latitude lines of a globe. MCMB graphite also has low internal porosity, and therefore resists particle deformation upon calendering, and good cycle life performance. However, MCMB graphite has high material costs and low capacity. In some examples, the second plurality of active material particles comprises a blend of spherical natural graphite with an artificial and/or synthetic spherical graphite, such as MCMBs.

In some examples, the first plurality of active material particles comprise artificial and/or synthetic graphites. Artificial graphites typically have a less uniform (AKA polydisperse) distribution of particle sizes when compared with synthetic graphites and may have less defined structures resulting from their manufacturing process. Artificial graphites are typically not spheroidized given significant yield loss (up to 50%) of fine graphite during the spheroidization process, which significantly increases manufacturing costs. Less-defined particle morphology (e.g., flake-like, oblong, cotton-candy-like, etc.) and polydispersity enable artificial graphites to pack better with higher efficiency but generally higher tortuosity than spherical natural graphites. However, high-aspect ratio natural graphites, such as flake graphite, may pack more efficiently in a layered (e.g., flat) manner, with their basal planes oriented parallel to the current collector. This packing topology results in very high tortuosity, which reduces rate capability of the electrode.

In some examples, the electrode having high top layer sphericity is a cathode in which spherical active materials (e.g., polycrystalline NMC and NCA) are coated on top of irregular-shaped active materials (e.g., LCO). In some cathode examples, the second plurality of active material particles comprise any suitable spherical cathode material, such as transition metals, transition metal oxides, and/or the like. In some cathode examples, the second plurality of active material particles comprise spherical nickel-containing transition metal oxides, such as lithium nickel manganese cobalt oxides (NMC), lithium nickel cobalt aluminum oxides (NCA), and/or the like. In some cathode examples, the second plurality of active material particles comprise polycrystalline particles, which comprise a plurality of monocrystalline “grains” that together make up a particle including “grain boundaries” disposed between grains. In some cathode examples, the first plurality of active material particles comprise any suitable non-spherical (e.g., irregularly-shaped) cathode material, such as transition metals, transition metal oxides, and/or the like. In some cathode examples, the first plurality of active material particles comprise irregularly shaped (e.g., non-spherical, high-aspect ratio) transition metal oxides, such as lithium cobalt oxides (LCO).

A method of manufacturing electrodes (e.g., anodes) having high top rate sphericity may include layering a first active material layer comprising a first plurality of active material particles having a first particle sphericity and a first particle size onto a current collector, layering a second active material layer comprising a second plurality of active material particles having a second particle sphericity greater than the first particle sphericity and a second particle size onto the first active material layer, drying the electrode, and calendering the electrode.

Examples, Components, and Alternatives The following sections describe selected aspects of illustrative anodes having high top layer sphericity as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Electrodes and Electrochemical Cells

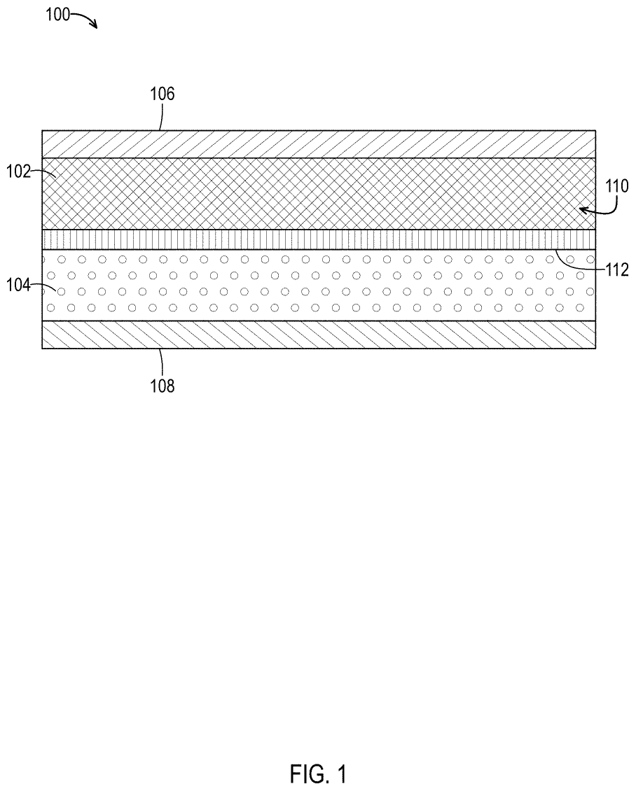

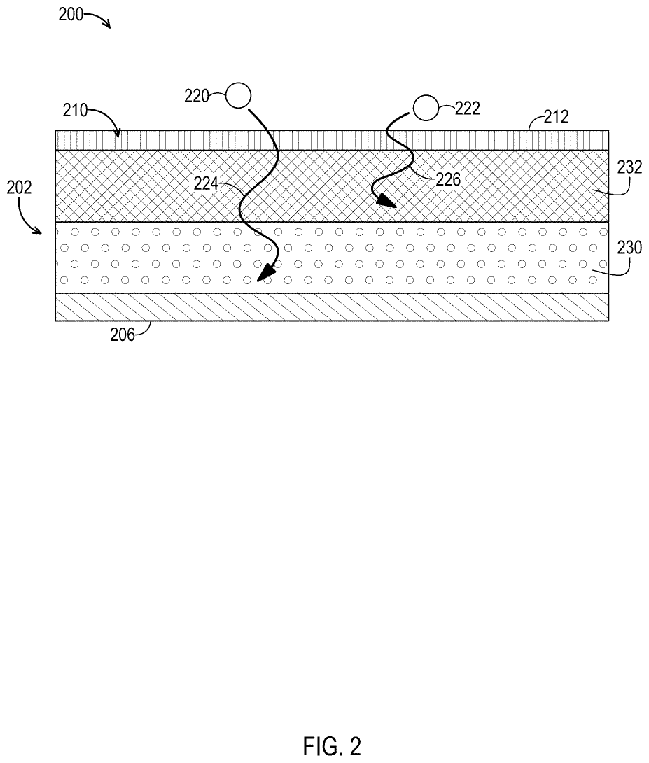

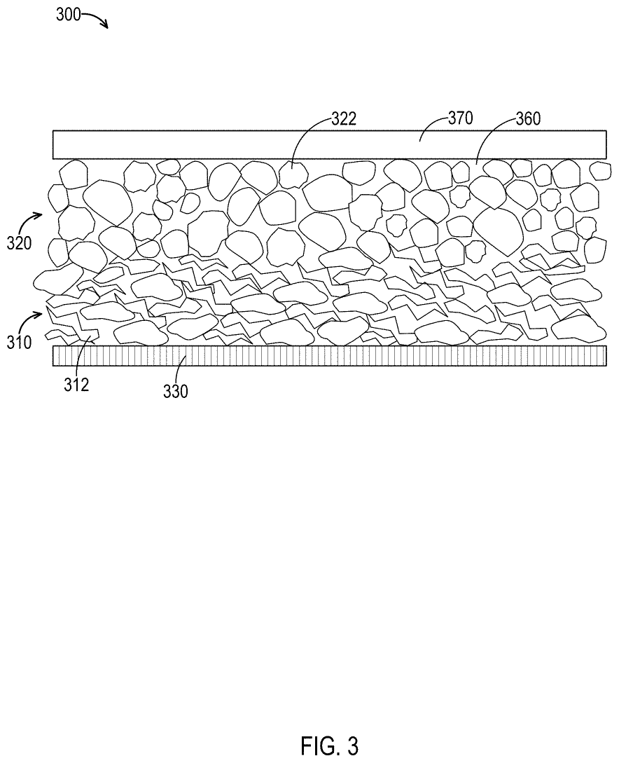

As shown in FIGS. 1-3, this section describes illustrative electrodes and electrochemical cells in accordance with aspects of the present disclosure. FIG. 1 is a schematic sectional diagram of an illustrative electrochemical cell, and FIGS. 2 and 3 are schematic sectional diagrams of two different types of illustrative multilayer electrodes suitable for use in an electrochemical cell.

Referring now to FIG. 1, an electrochemical cell 100 is illustrated in the form of a lithium-ion battery. Electrochemical cell 100 includes a positive and a negative electrode, namely a cathode 102 and an anode 104. The cathode and anode are sandwiched between a pair of current collectors 106, 108, which may comprise metal foils or other suitable substrates. Current collector 106 is electrically coupled to cathode 102, and current collector 108 is electrically coupled to anode 104. The current collectors enable the flow of electrons, and thereby electrical current, into and out of each electrode. An electrolyte 110 disposed throughout the electrodes enables the transport of ions between cathode 102 and anode 104. In the present example, electrolyte 110 includes a liquid solvent and a solute of dissolved ions. Electrolyte 110 facilitates an ionic connection between cathode 102 and anode 104.

Electrolyte 110 is assisted by a separator 112, which physically partitions the space between cathode 102 and anode 104. Separator 112 is liquid permeable, and enables the movement (i.e., flow) of ions within electrolyte 110 and between each of the electrodes. In some embodiments, electrolyte 110 includes a polymer gel or solid ion conductor, augmenting or replacing (and performing the function of) separator 112.

Cathode 102 and anode 104 are composite structures, which comprise active material particles, binders, conductive additives, and pores (i.e., void space) into which electrolyte 110 may penetrate. An arrangement of the constituent parts of an electrode is referred to as a microstructure, or more specifically, an electrode microstructure.

In some examples, the binder is a polymer, e.g., polyvinylidene difluoride (PVdF), and the conductive additive typically includes a nanometer-sized carbon, e.g., carbon black or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber.

In some examples, the chemistry of the active material particles differs between cathode 102 and anode 104. For example, anode 104 may include graphite (artificial or natural), hard carbon, titanate, titania, transition metals in general, elements in group 14 (e.g., carbon, silicon, tin, germanium, etc.), oxides, sulfides, transition metals, halides, and/or chalcogenides. On the other hand, cathode 102 may include transition metals (for example, nickel, cobalt, manganese, copper, zinc, vanadium, chromium, iron), and their oxides, phosphates, phosphites, and/or silicates. In some examples, the cathode may include alkalines and alkaline earth metals, aluminum, aluminum oxides and aluminum phosphates, halides and/or chalcogenides. In an electrochemical device, active materials participate in an electrochemical reaction or process with a working ion to store or release energy. For example, in a lithium-ion battery, the working ions are lithium ions.

Electrochemical cell 100 may include packaging (not shown). For example, packaging (e.g., a prismatic can, stainless steel tube, polymer pouch, etc.) may be utilized to constrain and position cathode 102, anode 104, current collectors 106 and 108, electrolyte 110, and separator 112.

For electrochemical cell 100 to properly function as a secondary battery, active material particles in both cathode 102 and anode 104 must be capable of storing and releasing lithium ions through the respective processes known as lithiating and delithiating. Some active materials (e.g., layered oxide materials or graphitic carbon) fulfill this function by intercalating lithium ions between crystal layers. Other active materials may have alternative lithiating and delithiating mechanisms (e.g., alloying, conversion).

When electrochemical cell 100 is being charged, anode 104 accepts lithium ions while cathode 102 donates lithium ions. When a cell is being discharged, anode 104 donates lithium ions while cathode 102 accepts lithium ions. Each composite electrode (i.e., cathode 102 and anode 104) has a rate at which it donates or accepts lithium ions that depends upon properties extrinsic to the electrode (e.g., the current passed through each electrode, the conductivity of the electrolyte 110) as well as properties intrinsic to the electrode (e.g., the solid state diffusion constant of the active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging) anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is lesser than the first rate, the second rate of the cathode would be a limiting rate. In some examples, the differences in rates may be so dramatic as to limit the overall performance of the lithium-ion battery (e.g., cell 100). Reasons for the differences in rates may depend on a tortuosity of a path through the electrode. In some examples, additional or alternative factors may contribute to the electrode microstructure and affect these rates.

Turning to FIG. 2, a schematic sectional view of a portion of an electrochemical cell 200 is depicted. Cell 200 has a multilayered electrode 202, shown accepting lithium ions 220 and 222 during a lithiation process. Cell 200 is an example of electrochemical cell 100 of FIG. 1, and includes a separator 212, an electrolyte 210, and a current collector 206. Electrode 202 may be a cathode or an anode, and includes a first layer 230 and a second layer 232. First layer 230 is adjacent current collector 206; second layer 232 is located adjacent (intermediate) the first layer and separator 212. For consistency, all examples of the present disclosure follow a similar convention, where the “first” layer is defined adjacent the current collector and the “second” layer is defined adjacent the separator. First layer 230 and second layer 232 may each be substantially planar, with thicknesses measured relative to a direction perpendicular to current collector 206.

In the present example, electrode 202 is depicted as accepting lithium, for example under a constant potential or constant current, such that lithium ions 220 and 222 are induced to react (e.g., intercalate) with active material present within first layer 230 and second layer 232. Lithium ions 220 and 222 migrate toward current collector 206 under diffusive and electric field effects. In this example, ion 220 follows a path 224 within electrolyte 210, through separator 212, second layer 232, and a portion of first layer 230, until it lithiates an active material particle within first layer 230. In contrast, lithium ion 222 follows a path 226 within electrolyte 210, through separator 212 and a portion of second layer 232, until it lithiates an active material particle within second layer 232.

In general, path 224 of the ion traveling through the separator to active material within the first layer will be longer than path 226 of the ion traveling through the separator to active material within the second layer. Additionally, the ion on path 224 travels a longer distance while in second layer 232 than does the ion on path 226. Generally, an expediency of paths 224 and 226 may generally be referred to as “tortuosity.” As a path becomes more tortuous, an impedance of the electrochemical cell increases, and a potential charging and discharging speed of the electrochemical cell decreases.

In a standard electrode, one consequence of the disparity in path lengths 224 and 226 is that a residence time in the second layer is likely to be greater than a residence time in the first layer for a given lithium ion. Another consequence of the disparity in path lengths 224 and 226 is that a lithium ion entering electrode 202 is more likely to react with an active material particle within second layer 232 than first layer 230. Accordingly, a gradient reaction field may be generated in such electrodes, which may negatively impact cell performance by: (1) a polarization overpotential in electrolyte 210 leading to parasitic energy losses within the electrochemical cell; and (2) underutilization of active material of first layer 230 compared to the active material of second layer 232 (causing, e.g., lower apparent lithium-ion battery capacity and/or longer time to compete acceptance of lithium by electrode 202 at lower power).

However, in the present example, the disparity in path lengths and resulting gradient reaction field is at least partially mitigated by electrode 202 having a first active material included in first layer 230 and a second active material included in second layer 232. The second active material is configured to be different from the first active material, such that the second active material includes particles which are substantially more spherical than particles included in the first active material and the second active material includes particles which are substantially larger than particles included in the first active material.

The most important parameter defining electrode tortuosity is the morphology of active materials included within electrode layers. As large, spherical particles are generally less closely-packed than smaller, less spherical particles, a path tortuosity through the second electrode layer may be less than a path tortuosity through the first electrode layer. The second electrode layer has more free space between active particles than the first active material layer, such that particles diffuse more easily through the second electrode layer. Accordingly, the second electrode layer has a higher overall tortuosity than the first electrode layer and a higher effective diffusivity than the first electrode layer. Increasing an expediency of ion travel through the second electrode layer may decrease ion residence time in the second layer and decrease a likelihood of reactivity between the ion and active material particles disposed within the second layer. Including active material particles having high sphericity therefore increases utilization of the active material of first layer 230.

In this example, a thickness of second layer 232 is chosen to be equal to or less than a selected maximum thickness. The maximum thickness is determined by the microscopic architecture of second layer 232, i.e., active material particles with distinct shapes and sizes arranged in a particular way in three-dimensional space. The factors that describe this microscopic architecture include a distribution of the active material particle sizes, a porosity, and a tortuosity within the second layer. If second layer 232 has a thickness greater than the maximum thickness, transport through the second layer to the first layer may become so tortuous that the benefit of high particle sphericity and large particle size may be diminished.

### B. Illustrative Multilayered Anode

As shown in FIGS. 3-5, this section describes an illustrative multilayered anode 300. Multilayered anode 300 (see FIG. 3) is an example of anodes having high top layer sphericity, described above.

Anode 300 includes a first (AKA bottom) active material layer 310 including a first plurality of active material particles 312 having a first average particle sphericity and a first particle size, layered onto and directly contacting a current collector 330, and a second (AKA top) active material layer 320 including a second plurality of active material particles 322 having a second average particle sphericity greater than the first average particle sphericity and a second particle size, layered onto and directly contacting the first active material layer. The active material particles in both the top and bottom layers may be mixed with binders, conductive additives, and/or other additives to form an active material composite. In some examples, the binder is a polymer, e.g., polyvinylidene difluoride (PVdF), and the conductive additive typically includes a nanometer-sized carbon, e.g., carbon black or graphite. In some examples, the binder is a mixture of carboxyl-methyl cellulose (CMC) and styrene-butadiene rubber (SBR). In some examples, the conductive additive includes a ketjen black, a graphitic carbon, a low dimensional carbon (e.g., carbon nanotubes), and/or a carbon fiber. An electrolyte 360 may be disposed throughout the cathode. In some examples, anode 300 may include a separator 370 disposed on a top surface. In some examples, the second particle size is greater than the first particle size. In some examples, the second plurality of active material particles have a D50 (AKA mass-median diameter) greater than 15 μm.

As described above with respect to electrode 200, the best way to reduce tortuosity in multilayered electrode design is to utilize large particles with a high degree of sphericity in the top electrode layer. Particle sphericity may be defined in a variety of ways, and particles having a high degree of sphericity may satisfy at least two of the following conditions:

$$Sphericity of silhouette ( of cross - sectional profile ) = \frac{{r}_{max - in}}{{r}_{min - cir}} \geq 0.6$$

wherein rₘₐₓ₋ᵢₙ refers to the radius of the largest circle that can be inscribed within the particle silhouette, and wherein r_{min-cir} refers to the radius of the smallest circle that fully circumscribes the particle silhouette.

$$Circularity of silhouette ( of cross - sectional profile ) = \frac{4 π * area}{{perimeter}^{2}} \geq 0.6$$

$$Roundness of silhouette ( of cross - sectional profile ) = \frac{area}{π * major {axis}^{2}} \geq 0.5$$

$$Aspect ratio of silhouette ( of cross - sectional profile ) = \frac{major axis}{minor axis} \leq 2$$

In some examples, the sphericity of silhouette of a cross-sectional profile refers to an average sphericity of silhouette of the average cross-sectional profiles of each active material particle. In some examples, the sphericity of silhouette of a cross-sectional profile refers to an average sphericity of silhouette of active material particles measured at a specific cross-section of the electrode. In some examples, the circularity of silhouette of a cross-sectional profile refers to an average circularity of silhouette of the average cross-sectional profiles of each active material particle. In some examples, the circularity of silhouette of a cross-sectional profile refers to an average circularity of silhouette of active material particles measured at a specific cross-section of the electrode. In some examples, the roundness of silhouette of a cross-sectional profile refers to an average roundness of silhouette of the average cross-sectional profiles of each active material particle. In some examples, the roundness of silhouette of a cross-sectional profile refers to an average roundness of silhouette of active material particles measured at a specific cross-section of the electrode. In some examples, the aspect ratio of silhouette of a cross-sectional profile refers to an average aspect ratio of silhouette of the average cross-sectional profiles of each active material particle. In some examples, the aspect ratio of silhouette of a cross-sectional profile refers to an average aspect ratio of silhouette of active material particles measured at a specific cross-section of the electrode.

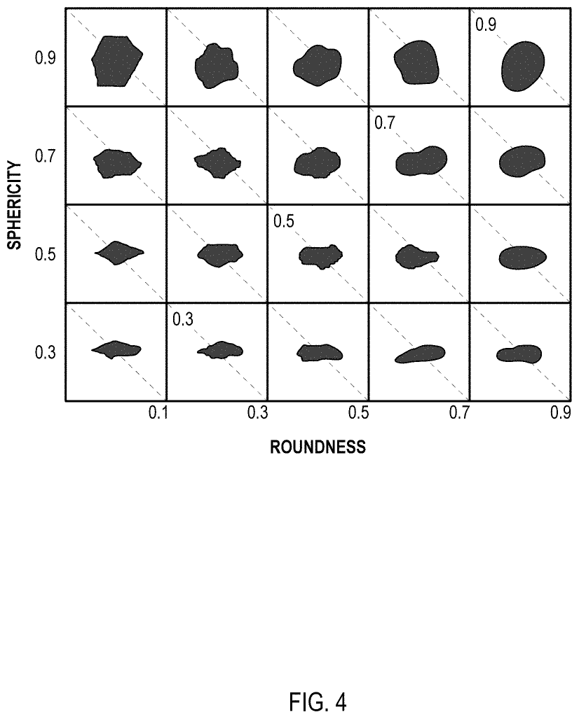

For an active material layer to have a high degree of sphericity, at least 50% of active materials included in the top layer may satisfy at least two of the above conditions. In some examples, particles having a high degree of a single parameter may be suitable for inclusion in the top electrode layer while not necessarily satisfying an additional parameter. As depicted in FIG. 4, particles having a sphericity greater than 0.7 and a roundness greater than 0.6, particles having a sphericity greater than 0.8 and a roundness greater than 0.5, and particles having a sphericity greater than 0.9 may be suitable for inclusion in the top electrode layer. Particles having both a roundness of silhouette greater than 0.5 and a sphericity greater than 0.7 are ideal for inclusion in the top electrode layer.

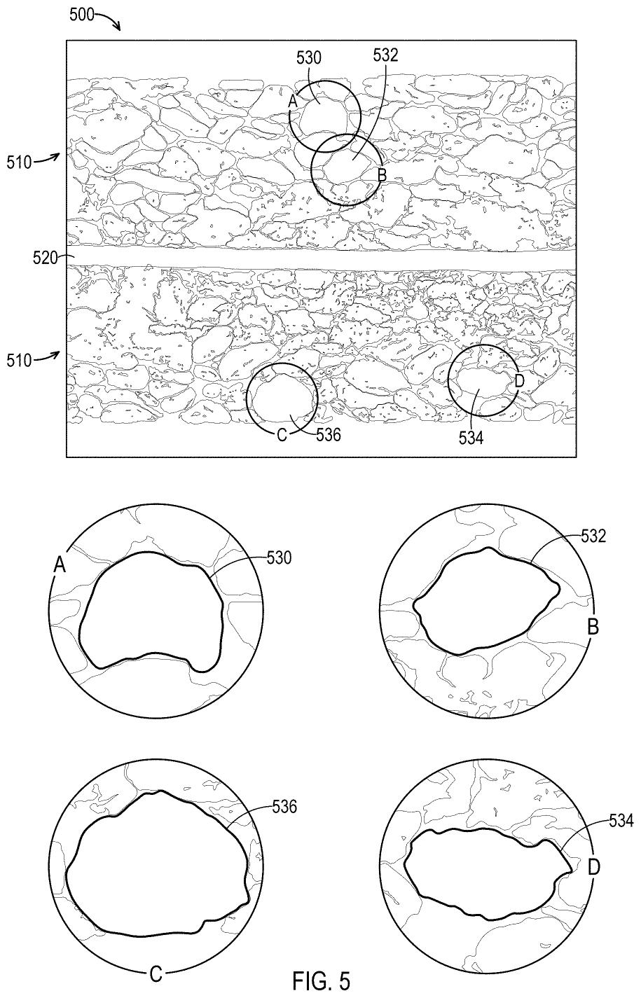

Suitable shapes for active material particles included in the top electrode layer are depicted in FIG. 5. FIG. 5 depicts a cross-section of an electrode portion 500 including two multi-layered anodes 510 disposed on opposing sides of a current collector 520. Particles 530, 532, 534, and 536 exhibit suitable shapes for inclusion in the top electrode layer. Particle 530 exhibits a circularity of 0.740, a roundness of 0.722, and an aspect ratio of 1.295. Particle 532 exhibits a circularity of 0.776, a roundness of 0.695, and an aspect ratio of 1.439. Particle 534 exhibits a circularity of 0.685, a roundness of 0.538, and an aspect ratio of 1.859. Particle 536 exhibits a circularity of 0.822, a roundness of 0.776, and an aspect ratio of 1.289.

In contrast, active material particles included in the bottom electrode layer are generally less spherical than active material particles included in the top electrode layer. Accordingly, at least 50% of active material particles included in the bottom electrode layer satisfy at least one of the following conditions:

$$Circularity of Silhouette ( of cross - sectional profile ) = \frac{4 π * area}{{perimeter}^{2}} < 0.6$$

$$Roundness of silhouette ( of cross - sectional profile ) = \frac{area}{π * major {axis}^{2}} \leq 0.5$$

$$Aspect ratio of silhouette ( of cross - sectional profile ) = \frac{major axis}{minor axis} > 2$$

Conditions described above refer to active material particles included in calendered electrodes. Electrode particles may be analyzed using cross-sectional analysis, (e.g., ion-milling, focused-ion beam, scanning electron microscope) to determine if the electrode particles meet the above conditions.

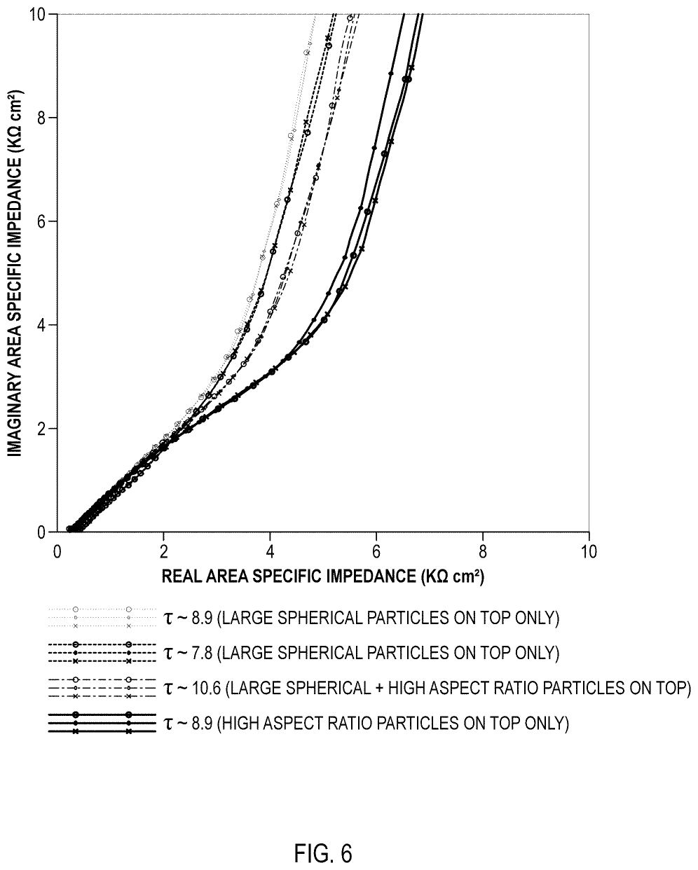

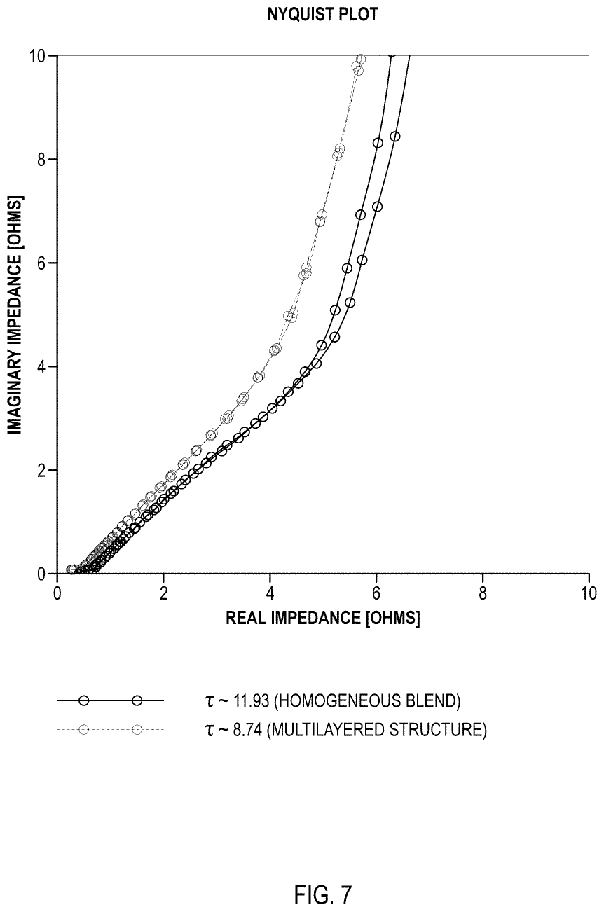

As depicted in FIGS. 6 and 7, anodes having the configuration of layers illustrated with respect to anode 300 have a lower specific impedance than anodes having alternative configurations. FIG. 6 is a Nyquist plot obtained via electrochemical impedance spectroscopy of symmetric cells. Electrochemical impedance spectroscopy utilizes a “blocking” electrolyte, or an electrolyte that contains no lithium salt to participate in Faradaic reactions, in order to quantify electrode tortuosity. The plot depicts the tortuosities of four electrochemical cells, a first cell including only large spherical particles in a top layer, a second cell including only large spherical particles in a top layer, a cell including a mixture of large spherical particles and high aspect ratio particles (e.g., non-spherical) in a top layer, and a cell including only high aspect ratio particles (e.g., non-spherical) in a top layer. As depicted in FIG. 6, cells including spherical particles in a top layer have lower tortuosities than those that include non-spherical particles, and a mixture of the two particle morphologies results in an intermediate tortuosity.

FIG. 7 is another Nyquist plot depicting tortuosities of two electrochemical cells including particles having two distinct particle morphologies arranged in different configurations: a homogeneous blend of particles, and a multilayered structure having layers with distinct particle morphologies. As depicted in FIG. 7, electrodes having a multilayered structure have a lower tortuosity than electrodes including a mixture of particle morphologies within a single electrode layer. Multilayered electrodes including distinct layers of particles having different morphologies reduce tortuosity within the electrode, improve liquid-phase mass transport, and improve rate capability upon charging and discharging.

In some examples, the first active material particles have a first average particle sphericity, the second active material particles have a second average particle sphericity, and the second average particle sphericity is greater than the first average particle sphericity. In some examples, the first average particle sphericity and the second average particle sphericity refer to a mean of the particle sphericities of all active material particles included within the first and second layer, respectively. In some examples, the first average particle sphericity and the second average particle sphericity refer to a median of the particle sphericities of all active material particles included within the first and second layer, respectively. In some examples, the second average particle sphericity may be greater than the first average particle sphericity by the second active material particles having one or more modes of particle sphericity greater than a highest mode of particle sphericity of the first active material particles.

The second plurality of active material particles may comprise any suitable graphitic carbon material having high particle sphericity and large particle size, such as spherical natural graphite, mesocarbon microbead graphite, spheroidized artificial graphites, and/or the like. In some examples, the second plurality of active material particles comprise a spherical natural graphite. Spherical natural graphite is low-cost, has high capacity, and has high-rate capability given its spheroidized morphology, which provides graphite edge-plane access all around the particle surface (as opposed to flake graphite, which provides graphite edge-plane access only at particle edges). However, spherical natural graphite has internal porosity, which may lead to some loss of sphericity upon calendering, and may lead to reduced cycle life due to material impurities found in natural graphite raw material. In some examples, the second plurality of active material particles comprise a mesocarbon microbead (MCMB) graphite, which is an artificial and/or synthetic graphite. MCMB graphite has a high degree of sphericity. Brooks-Taylor structure from mesophase graphite results in a high degree of edge-plane access all around the particle surface (different from that found in natural graphite), which yields high rate capability. While natural graphite also provides edge-plane access, natural graphite includes overlapping graphite sheets (e.g., like a cabbage). MCMB graphites have edge planes disposed similarly to the latitude lines of a globe. MCMB graphite also has low internal porosity, and therefore resists particle deformation upon calendering, and good cycle life performance. However, MCMB graphite has high material costs and low capacity when compared with spherical natural graphite. In some examples, the second plurality of active material particles comprises a blend of spherical natural graphite with an artificial and/or synthetic spherical graphite, such as MCMB. In some examples, the second plurality of active material particles comprise other suitable anode materials that satisfy the sphericity condition.

The first plurality of active material particles may comprise any graphitic carbon material having a high aspect ratio and low sphericity, such as flake graphite, artificial and/or synthetic graphites, and/or the like. In some examples, the first plurality of active material particles comprise artificial and/or synthetic graphites. Artificial graphites typically have a less uniform (AKA polydisperse) distribution of particle sizes when compared with than natural (e.g., flake) graphites and may have less defined structures resulting from their manufacturing process. Artificial graphites are typically not spheroidized given significant yield loss (up to 50%) of fine graphite in the spheroidization process, significantly increasing manufacturing costs. Less-defined particle morphology (e.g., flake-like, oblong, cotton-candy-like, etc.) and polydispersity enable artificial graphites to pack better with higher efficiency but generally higher tortuosity. In some examples, the first plurality of active material artificial and/or synthetic graphites are graphitized from isotropic coke.

In some examples, the first active material particles of the first layer may have a first distribution of sizes (e.g., by volume) greater than a second distribution of sizes (e.g., by volume) of the second active material particles of the second layer. In some examples, the first active material particles may have a distribution of particle sizes which is less uniform (AKA more polydisperse) than the second active material particles. In some examples, the first active material particles may be smaller than the second active material particles by having a median particle size (e.g., by volume) smaller than a median particle size (e.g., by volume) of the second distribution. In some examples, the first active material particles may be smaller than the second active material particles by having a mean particle size (e.g., by volume) smaller than a mean particle size (e.g., by volume) of the second distribution. In some examples, the first active material particles may be smaller than the second active material particles by having one or more modes of particle size (e.g., by volume) smaller than a lowest mode of particle size (e.g., by volume) of the second active material particles.

In some examples, the first active material layer has a first particle distribution range and the second active material layer has a second particle distribution range, and the first particle distribution range is broader than the second particle distribution range (i.e., the first particle distribution range includes particles having a broader range of sizes than the second particle distribution range). The first particle distribution range refers to a difference in size (e.g., by mass, volume, diameter, etc.) between a largest active particle included within the first active material layer and a smallest active particle included within the first active material layer. Similarly, the second particle distribution range refers to a difference in size (e.g., by mass, volume, diameter, etc.) between a largest active particle included within the second active material layer and a smallest active particle included within the second active material layer. In other words, the first active material layer has a greater difference in size between the largest active particle and the smallest active particle included within the first active material layer than the second active material layer. In some examples, the first active material particles are highly polydisperse in particle size. In some examples, the first active material particles have a non-uniform distribution of particle sizes. In some examples, the first active material particles have a bi-modal distribution of particle sizes, thereby increasing layer compaction. In some examples, the second active material particles are monodisperse. In some examples, the second active material particles have a uniform distribution of particle sizes.

### C. Illustrative Anode Manufacturing Method

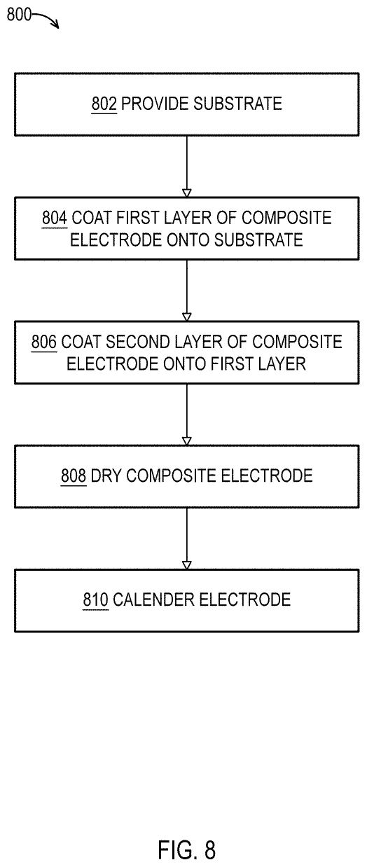

This section describes steps of an illustrative method 800 for manufacturing anodes having high top layer sphericity; see FIG. 8. Aspects of electrodes, electrochemical cells, and manufacturing devices described herein may be utilized in the method steps described below. Where appropriate, reference may be made to components and systems that may be used in carrying out each step. These references are for illustration, and are not intended to limit the possible ways of carrying out any particular step of the method.

FIG. 8 is a flowchart illustrating steps performed in an illustrative method, and may not recite the complete process or all steps of the method. Although various steps of method 800 are described below and depicted in FIG. 8, the steps need not necessarily all be performed, and in some cases may be performed simultaneously or in a different order than the order shown.

Step 802 of method 800 includes providing a substrate, wherein the substrate includes any suitable structure and material configured to function as a conductor in a secondary battery of the type described herein. In some examples, the substrate comprises a current collector. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out.

Method 800 next includes a plurality of steps in which at least a portion of the substrate is coated with an electrode material composite. This may be done by causing a current collector substrate and an electrode material composite dispenser to move relative to each other, by causing the substrate to move past an electrode material composite dispenser (or vice versa) that coats the substrate as described below. The composition of material particles in each electrode material composite layer may be selected to achieve the benefits, characteristics, and results described herein. The electrode material composite may include one or more electrode layers, including a plurality of active material particles.

Step 804 of method 800 includes coating a first layer of a composite anode on a first side of the substrate. In some examples, the first layer may include a plurality of first particles adhered together by a first binder, the first particles having a first average particle sphericity and a first average particle size (or other first particle distribution). In some examples, the plurality of first particles comprise a plurality of first active material particles. In some examples, the first active material particles comprise any graphitic carbon material having a high aspect ratio and low particle sphericity, such as flake graphite, artificial and/or synthetic graphites, and/or the like. In some examples, the first plurality of active material particles comprise artificial and/or synthetic graphites. In some examples, the first plurality of active materials have a circularity of silhouette less than 0.6. In some examples, the first plurality of active materials have a roundness of silhouette less than or equal to 0.5. In some examples, the first plurality of active materials have an aspect ratio of silhouette greater than 2.

The coating process of step 804 may include any suitable coating method(s), such as slot die, blade coating, spray-based coating, electrostatic jet coating, or the like. In some examples, the first layer is coated as a wet slurry of solvent, e.g., water or NMP(N-Methyl-2-pyrrolidone), binder, conductive additive, and active material. In some examples, the first layer is coated dry, as an active material with a binder and/or a conductive additive. Step 804 may optionally include drying the first layer of the composite electrode.

Step 806 of method 800 includes coating a second layer onto the first layer, forming a multilayered (e.g., stratified) structure. The second layer may include a plurality of second particles adhered together by a second binder, the second particles having a second average particle sphericity and a second average particle size (or other second particle distribution). In some examples, the plurality of second particles comprise a plurality of second active material particles. The second average particle sphericity is greater than the first average particle sphericity. In some examples, the second average particle size is greater than the first average particle size. In some examples, the plurality of second active material particles have a D50 (AKA mass-median diameter) greater than 15 μm.

The plurality of second active materials are highly spherical, which means that at least 50% of the active materials in the second layer satisfy at least two of the following conditions: sphericity of silhouette is greater than or equal to 0.6, circularity of silhouette is greater than or equal to 0.6, roundness of silhouette is greater than or equal to 0.5, and aspect ratio of silhouette is less than or equal to 2.

The second plurality of active material particles may comprise any suitable graphitic carbon material having high particle sphericity and large particle size, such as spherical natural graphite, mesocarbon microbead graphite, spheroidized artificial graphites, and/or the like. In some examples, the second plurality of active material particles comprise a spherical natural graphite. In some examples, the second plurality of active material particles comprise a mesocarbon microbead (MCMB) graphite, which is an artificial and/or synthetic graphite. In some examples, the second plurality of active material particles comprises a blend of spherical natural graphite with an artificial and/or synthetic spherical graphite, such as MCMB.

The coating process of step 806 may include any suitable coating method(s), such as slot die, blade coating, spray-based coating, electrostatic jet coating, or the like. In some examples, the second layer is coated as a wet slurry of solvent, e.g., water or NMP(N-Methyl-2-pyrrolidone), binder, conductive additive, and active material. In some examples, the second layer is coated dry, as an active material with a binder and/or a conductive additive.

In some examples, steps 804 and 806 may be performed substantially simultaneously. For example, both of the slurries may be extruded through their respective orifices simultaneously. This forms a two-layer slurry bead and coating on the moving substrate. In some examples, difference in viscosities, difference in surface tensions, difference in densities, difference in solids contents, and/or different solvents used between the first active material slurry and the second active material slurry may be tailored to cause interpenetrating finger structures at the boundary between the two composite layers. In some embodiments, the viscosities, surface tensions, densities, solids contents, and/or solvents may be substantially similar. Creation of interpenetrating structures, if desired, may be facilitated by turbulent flow at the wet interface between the first active material slurry and the second active material slurry, creating partial intermixing of the two slurries.

To facilitate proper curing in the drying process, the first layer (closest to the current collector) may be configured (in some examples) to be dried from solvent prior to the second layer (further from the current collector) so as to avoid creating skin-over effects and blisters in the resulting dried coatings.

In some examples, any of the described steps may be repeated to form three or more layers. For example, an additional layer or layers may include active materials. Any method described herein to impart structure between the first active material layer and the second active material layer may be utilized to form similar structures between any additional layers deposited during the manufacturing process.

Method 800 may further include drying the composite electrode in step 808, and/or calendering the composite electrode in step 810. Both the first and second layers may experience the drying process and the calendering process as a combined structure. In some examples, step 808 may be combined with calendering step 810(e.g., in a hot roll process). In some examples, drying step 808 includes a form of heating and energy transport to and from the electrode (e.g., convection, conduction, radiation) to expedite the drying process. In some examples, calendering in step 810 is replaced with another compression, pressing, or compaction process. In some examples, calendering the electrode may be performed by pressing the combined first and second layers against the substrate, such that electrode density is increased in a non-uniform manner, with the first layer having a first porosity and the second layer having a lower second porosity.

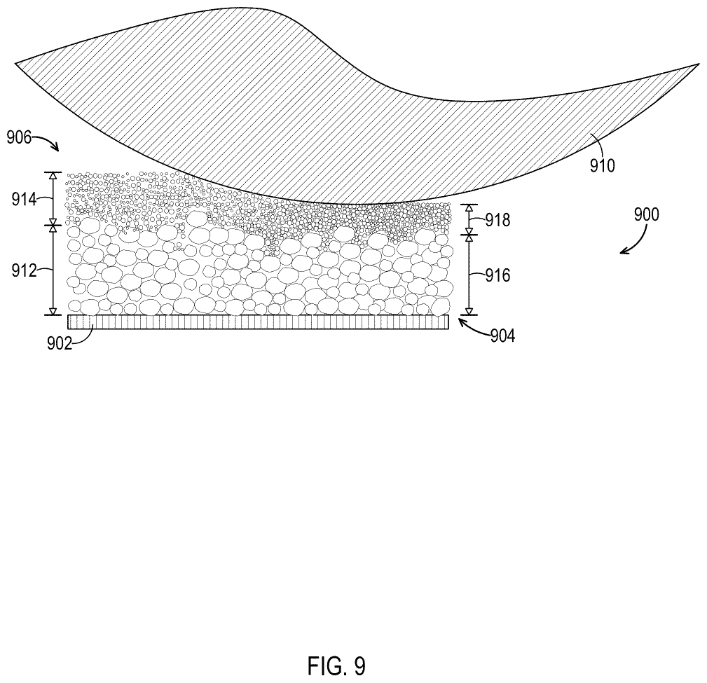

FIG. 9 shows an electrode undergoing the calendering process, in which particles in a second layer 906 can be calendered with a first layer 904. This may prevent a “crust” formation on the electrode, specifically on the first active material layer. A roller 910 may apply pressure to a fully assembled electrode 900. Electrode 900 may include first layer 904 and second layer 906 applied to a substrate web 902. First layer 904 may have a first uncompressed thickness 912 and second layer 906 may have a second uncompressed thickness 914 prior to calendering. After the electrode has been calendered, first layer 904 may have a first compressed thickness 916 and second layer 906 may have a second compressed thickness 918.

### D. Illustrative Manufacturing System

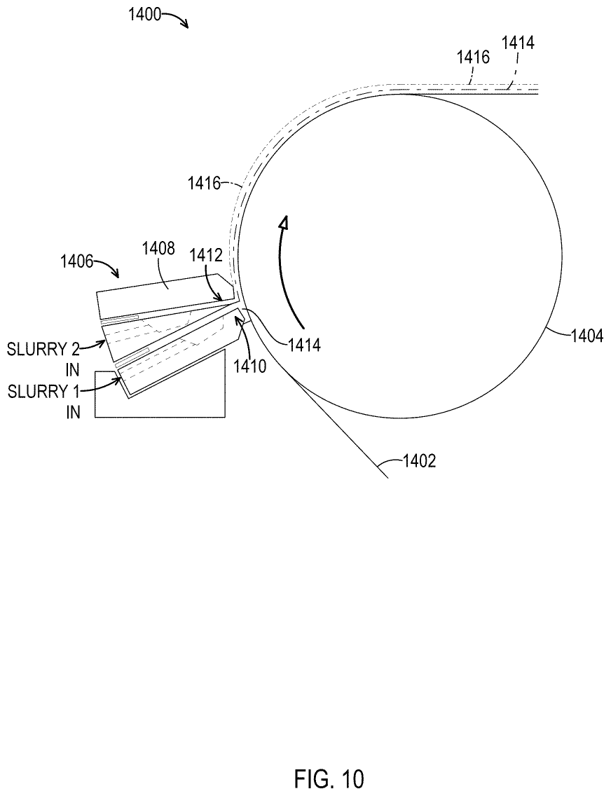

Turning to FIG. 10, an illustrative manufacturing system 1400 for use with method 800 will now be described. In some examples, a slot-die coating head with at least two fluid slots, fluid cavities, fluid lines, and fluid pumps may be used to manufacture an anode having high top layer sphericity. The anode may include a top and a bottom active material layer, each having a specific particle sphericity. In some examples, additional cavities may be used to create additional active material layers.

In system 1400, a foil substrate 1402 is transported by a revolving backing roll 1404 past a stationary dispenser device 1406. Dispenser device 1406 may include any suitable dispenser configured to evenly coat one or more layers of slurry onto the substrate. In some examples, the substrate may be held stationary while the dispenser head moves. In some examples, both may be in motion. Dispenser device 1406 may, for example, include a dual chamber slot die coating device having a coating head 1408 with two orifices 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer. In the present disclosure, the first layer 1414 may be a bottom layer of anode active material and the second layer may be a top layer of anode active material.

Manufacturing method 800 may be performed using a dual-slot configuration, as described above, to simultaneously extrude the bottom and top anode active material layers, or a multi-slot configuration with three or more dispensing orifices used to simultaneously extrude an anode with three or more active material layers. In some embodiments, manufacturing system 1400 may include a tri-slot configuration, such that a first active material layer, a second active material layer, and a third active material layer may all be extruded simultaneously. In another embodiment, subsequent active material layers may be applied after a previous layer has first dried.

### E. Illustrative Combinations and Additional Examples

This section describes additional aspects and features of anodes having high top layer sphericity, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An electrode comprising:

a current collector substrate; and

an active material composite layered onto the current collector substrate, wherein the active material composite comprises:
a first layer on and directly contacting the first current collector substrate and including a plurality of first active material particles configured to have a first average particle sphericity and a first average particle size; and
a second layer layered onto and directly contacting the first layer and including a plurality of second active material particles configured to have a second average particle sphericity and a second average particle size;

wherein the second average particle sphericity is greater than the first average particle sphericity, such that the second layer has a lower tortuosity than the first layer.

A1. The electrode of paragraph A0, wherein the second average particle size is greater than the first average particle size.

A2. The electrode of paragraph A0 or A1, wherein the second average particle size is greater than 15 μm.

A3. The electrode of any of paragraphs A0 through A2, wherein at least 50% of particles included in the plurality of second active material particles meet at least two of the following conditions: a sphericity of silhouette is greater than or equal to 0.6, a circularity of silhouette is greater than or equal to 0.6, a roundness of silhouette is greater than or equal to 0.5, and an aspect ratio of silhouette is less than or equal to 2

A4. The electrode of paragraph A3, wherein at least 50% of particles included in the plurality of second active material particles have an average roundness of silhouette greater than 0.5 and an average sphericity greater than 0.7

A5. The electrode of any of paragraphs A0 through A4, wherein the plurality of first active material particles meets at least one of the following conditions: a circularity of silhouette is less than 0.6, a roundness of silhouette is less than or equal to 0.5, and an aspect ratio of silhouette is greater than 2.

A6. The electrode of any of paragraphs A0 through A5, wherein the electrode is an anode.

A7. The electrode of paragraph A6, wherein the plurality of first active material particles and the plurality of second active material particles comprise graphitic carbon.

A8. The electrode of paragraph A6 or A7, wherein the plurality of second active material particles comprises a spherical natural graphite.

A9. The electrode of paragraph A6 or A7, wherein the plurality of second active material particles comprises a mesocarbon microbead graphite.

A10. The electrode of paragraph A6 or A7, wherein the plurality of second active material particles comprises a mixture of spherical natural graphite and mesocarbon microbead graphite.

A11. The electrode of any of paragraphs A0 through A10, wherein the plurality of first active material particles comprises an artificial graphite.

A12. The electrode of any of paragraphs A0 through A11, wherein the first active material layer has a first particle distribution range and the second active material layer has a second particle distribution range, and wherein the first particle distribution range is broader than the second particle distribution range.

B0. An electrode comprising:

a current collector substrate;

a first active material layer layered onto and directly contacting the current collector substrate, the first active material layer comprising a plurality of first active material particles adhered together by a first binder, the plurality of first active material particles having a first average particle sphericity;

a second active material layer layered onto and directly contacting the first active material layer, the second active material layer comprising a plurality of second active material particles adhered together by a second binder, the plurality of second active material particles having a second average particle sphericity;

wherein the second average particle sphericity is greater than the first average particle sphericity, such that the second active material layer has a lower tortuosity than the first active material layer.

B1. The electrode of paragraph B1, wherein the first plurality of active material particles has a first average particle size, wherein the second plurality of active material particles has a second average particle size, and wherein the second average particle size is greater than the first average particle size.

B2. The electrode of paragraph B1, wherein the second average particle size is greater than 15 μm.

B3. The electrode of any of paragraphs B0 through B2, wherein at least 50% of particles included in the plurality of second active material particles meet at least two of the following conditions: a sphericity of silhouette is greater than or equal to 0.6, a circularity of silhouette is greater than or equal to 0.6, a roundness of silhouette is greater than or equal to 0.5, and an aspect ratio of silhouette is less than or equal to 2

B4. The electrode of paragraph B3, wherein at least 50% of particles included in the plurality of second active material particles have a roundness of silhouette greater than 0.5 and a sphericity greater than 0.7

B5. The electrode of any of paragraphs B0 through B4, wherein the plurality of first active material particles meets at least one of the following conditions: a circularity of silhouette is less than 0.6, a roundness of silhouette is less than or equal to 0.5, and an aspect ratio of silhouette is greater than 2.

B6. The electrode of any of paragraphs B0 through B5, wherein the electrode is an anode.

B7. The electrode of paragraph B6, wherein the plurality of first active material particles and the plurality of second active material particles comprise graphitic carbon.

B8. The electrode of paragraph B6 or B7, wherein the plurality of second active material particles comprises a spherical natural graphite.

B9. The electrode of paragraph B6 or B7, wherein the plurality of second active material particles comprises a mesocarbon microbead graphite.

B10. The electrode of paragraph B6 or B7, wherein the plurality of second active material particles comprises a mixture of spherical natural graphite and mesocarbon microbead graphite.

B11. The electrode of any of paragraphs B0 through B10, wherein the plurality of first active material particles comprises an artificial graphite.

B12. The electrode of any of paragraphs B0 through B11, wherein the first active material layer has a first particle distribution range and the second active material layer has a second particle distribution range, and wherein the first particle distribution range is broader than the second particle distribution range.

C0. A method of manufacturing an anode, the method comprising:
layering a first active material composite including a plurality of first active material particles onto a current collector, the first active material particles having a first average particle sphericity;
layering a second active material composite including a plurality of second active material particles onto the first active material composite, the second active material particles having a second average particle sphericity;
wherein the second average particle sphericity is greater than the first average particle sphericity, such that the second active material composite has a higher effective diffusivity than the first active material composite.

C1. The method of paragraph C0, further comprising calendering the electrode.

C2. The method of paragraph C0 or C1, wherein the first plurality of active material particles has a first average particle size, wherein the second plurality of active material particles has a second average particle size, and wherein the second average particle size is greater than the first average particle size.

C3. The method of paragraph C2, wherein the second average particle size is greater than 15 μm.

C4. The method of any of paragraphs C0 through C3, wherein at least 50% of particles included in the plurality of second active material particles meet at least two of the following conditions: a sphericity of silhouette is greater than or equal to 0.6, a circularity of silhouette is greater than or equal to 0.6, a roundness of silhouette is greater than or equal to 0.5, and an aspect ratio of silhouette is less than or equal to 2.

C5. The method of paragraph C4, wherein at least 50% of particles included in the plurality of second active material particles have a roundness of silhouette greater than 0.5 and a sphericity greater than 0.7

C6. The method of any of paragraphs C0 through C5, wherein the plurality of first active material particles meets at least one of the following conditions: a circularity of silhouette is less than 0.6, a roundness of silhouette is less than or equal to 0.5, and an aspect ratio of silhouette is greater than 2.

C7. The method of any of paragraphs C0 through C6, wherein the plurality of first active material particles and the plurality of second active material particles comprise graphitic carbon.

C8. The electrode of paragraph C7, wherein the plurality of second active material particles comprises a spherical natural graphite.

C9. The electrode of paragraph C7, wherein the plurality of second active material particles comprises a mesocarbon microbead graphite.

C10. The electrode of paragraph C6 or C7, wherein the plurality of second active material particles comprises a mixture of spherical natural graphite and mesocarbon microbead graphite.

Advantages, Features, and Benefits The different embodiments and examples of the anode having high top layer sphericity described herein provide several advantages over known solutions for reducing electrode impedance. For example, illustrative embodiments and examples described herein reduce electrode tortuosity, improve liquid-phase mass transport, and improve electrode rate capability.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An electrode comprising:
a current collector substrate; and
an active material composite disposed on the current collector substrate, wherein the active material composite comprises:
a first layer on and directly contacting the current collector substrate and comprising first active material particles having a first average particle sphericity and a first average particle size; and
a second layer on and directly contacting the first layer and comprising second active material particles having a second average particle sphericity and a second average particle size;
wherein the second average particle sphericity is greater than the first average particle sphericity, such that the second layer has a lower tortuosity than the first layer.

2. The electrode of claim 1, wherein the second average particle size is greater than the first average particle size.

3. The electrode of claim 2, wherein the second average particle size is greater than or equal to 15 μm.

4. The electrode of claim 1, wherein at least 50% of the second active material particles have an average roundness of silhouette greater than 0.5 and an average sphericity greater than 0.7.

5. The electrode of claim 1, wherein the electrode is an anode.

6. The electrode of claim 5, wherein the first and second layer comprise graphitic carbon.

7. The electrode of claim 6, wherein the second layer includes spherical natural graphite and mesocarbon microbead graphite.

8. The electrode of claim 1, wherein the first active material layer has a first particle distribution range and the second active material layer has a second particle distribution range, and wherein the first particle distribution range is broader than the second particle distribution range.

9. An electrode comprising:
a current collector substrate;
a first active material composite layer on and directly contacting the current collector substrate, the first active material layer comprising a plurality of first active material particles adhered together by a first binder, the plurality of first active material particles having a first average particle sphericity; and
a second active material composite layer on and directly contacting the first active material composite layer, the second active material composite layer comprising a plurality of second active material particles adhered together by a second binder, the plurality of second active material particles having a second average particle sphericity;
wherein the second average particle sphericity is greater than the first average particle sphericity, such that a the second active material composite layer has a lower tortuosity than the first active material composite layer.

10. The electrode of claim 9, wherein the first active material composite layer has a first average particle size, wherein the second active material composite layer has a second average particle size, and wherein the second average particle size is greater than the first average particle size.

11. The electrode of claim 10, wherein the second average particle size is greater than or equal to 15 μm.

12. The electrode of claim 9, wherein at least 50% of particles included in the plurality of second active material particles have a roundness of silhouette greater than 0.5 and a sphericity greater than 0.7.

13. The electrode of claim 12, wherein the electrode is an anode.

14. The electrode of claim 13, wherein the plurality of first active material particles and the plurality of second active material particles comprise graphitic carbon.

15. The electrode of claim 14, wherein the plurality of second active material particles comprises a mixture of spherical natural graphite and mesocarbon microbead graphite.

16. The electrode of claim 14, wherein the first active material layer has a first particle distribution range and the second active material layer has a second particle distribution range, and wherein the first particle distribution range is broader than the second particle distribution range.

17. A method of manufacturing an anode, the method comprising:
layering a first active material composite onto a current collector, the first active material composite comprising a plurality of first active material particles having a first average particle sphericity; and
layering a second active material composite onto the first active material composite, the second active material composite comprising a plurality of second active material particles having a second average particle sphericity;
wherein the second average particle sphericity is greater than the first average particle sphericity, such that the second active material composite has a higher effective diffusivity than the first active material composite.

18. The method of claim 17, further comprising calendering the anode.

19. The method of claim 17, wherein the first active material composite has a first average particle size, wherein the second active material composite has a second average particle size, and wherein the second average particle size is greater than the first average particle size.

20. The method of claim 17, wherein at least 50% of particles included in the plurality of second active material particles have a roundness of silhouette greater than 0.5 and a sphericity greater than 0.7.
